(19) United States
(12) Patent Application Publication
(10) Pub. No.: US 2005/0217175 A1
(43) Pub. Date: Oct. 6, 2005

(54) Modular water garden construction

(75) Inventors: Larry M. Leone, Euless, TX (US); J. Douglas Reinhart, Coppell, TX (US); Robert F. Leone, Hurst, TX (US)

Correspondence Address: KENNETH E. KUFFNER;ROBERTS & SMABY, SUITE 3000, 1717 MAIN STREET, DALLAS, TX, 75201, US

(73) Assignee: Modular Watergardens, LLC

(21) Appl. No.: 10/816,651

(22) Filed: Apr. 2, 2004

(51) Int. Cl. A01G 31/00

(52) U.S. Cl. 47/59 R

(57) ABSTRACT

A portable, modular water garden structure, suitable for the containment of water and adapted to be readily assembled and disassembled, is provided. The structure first comprises a base unit, formed of a lightweight sturdy material, having an exposed outer surface, a top side, perimeter walls and an underside. The base unit is further characterized as having on its top side a generally centrally located depressed area suitable for use as a tub capable of accommodating an appropriate quantity of water. A moisture-proof flexible membrane is situated directly over the exposed outer surface area of the base unit, and extending over the tub and at least a portion of the upper edge of the perimeter walls. A layer of moisture- and flex-resistant material is formed over the moisture-proof membrane, covering the membrane and at least covering the exposed outside surfaces of the perimeter walls and any exposed outer surfaces of the base, so as to give a generally natural-looking appearance to said modular structure. One or more natural or natural-appearing stones may be attached to and or imbedded in said material to add to the appearance of the structure, as desired.

### TECHNICAL FIELD OF THE INVENTION

The present invention generally relates to modular water gardens and, in particular, to a modular water garden construction that can be pre-fabricated, in whole or in part, conveniently moved from one location to another and/or constructed and installed on site. The modular structure disclosed in this application may be a complete water garden itself or may be combined as desired with one or more separate modular structure(s) to form a larger and more complex water garden unit.

### BACKGROUND OF THE INVENTION

For centuries people have enjoyed the beauty of fountains and water gardens in their public squares and private estates. Water gardens have become increasingly popular, as people have come to recognize the relaxing effect of water, whether it is the rhythmic waves of the ocean, a gently running brook, or the quiet beauty of a pond. While the ordinary consumer may be unable to recreate nature with oceans and brooks, they can find pleasure in water gardens, pools and spas.

Homeowners want to exchange their rakes, lawn mowers and weed eaters for a work free garden. Commercial landscape architects use water in their designs for effect and uniqueness and to create a natural focal point, whether located in the home garden, shopping mall, or office building. Others desire a water garden simply to enjoy the water, a haven for relaxation.

Just as one can personalize water gardens by the plants and fish put in or around it, the many different ways to build a water garden allows the user to tailor it to their own individual likes and needs. There are three conventional ways to create a water garden pool. Flexible plastic liners are lightweight and inexpensive and can be cut to any shape. However, installation is more time consuming than for molded water garden ponds. A concrete water garden pond (properly installed) allows for water gardens of unlimited size; but concrete water gardens are heavy, generally hard to maintain, and cannot be moved. Those concerned about the ease of installation, ease of repair, durability and portability use the pre-fabricated polyethylene pond or a tub water garden. Accessories, such as lights, waterfalls, or fountains, can then be added to or around the conventional water garden pond.

Unfortunately, in order to move even the pre-fabricated polyethylene pond to a different location, the entire water garden and its accompanying pump and plumbing must be completely disassembled and moved. Such disassembly can be quite complex, and often requires the expertise of a plumber. Even if a normal user is able to accomplish the disassembly on his or her own, such disassembly is very time-consuming and difficult, and any subsequently reassembly will be equally time-consuming and challenging. In other words, even the pre-fabricated polyethylene water gardens ponds and their surrounding rocks, waterfalls, and greenery tend to stay fixed in their original locations, and are unlikely to be moved to a different location.

Such lack of portability is a significant drawback, since present day homeowners are more mobile and commercial properties often change owners and tenants. It would be desirable if homeowners could easily move their water gardens to different locales and commercial property holders could conveniently and relatively inexpensively change the appearance of their property based on season, tenants or customers, while not experiencing the inconveniences and difficulties associated with having to assemble and disassemble a conventional water garden. This would encourage and promote increased use of water gardens.

Another drawback associated with conventional water gardens is that most water garden pools are not free standing nor do they possess the ability to be freestanding. Consequently, people who might have problems with bending or kneeling may find it difficult to maintain their water garden. It would be desirable to allow these people to enjoy the luxury and benefit of a water garden while eliminate getting down on the ground to feed and touch fish, and make it easier to clean the pond and skimmer.

Yet another drawback associated with conventional water gardens is that all of the plumbing system is typically provided outside the water garden. Unfortunately, conventional plumbing systems are quite susceptible to leaks (e.g., at the hose connections), which make it less desirable to use such conventional water gardens inside buildings.

In nature, all water features are cut out of natural stone and the stone is an integral part of that beauty. Manufacturers try to imitate the look with plaster, plastic, and concrete but rarely succeed. Despite recent improvements in conventional water garden construction, aesthetically, many of the pre-fabricated polyethylene water garden ponds do not utilize natural stone, as it is difficult and costly to affix and require costly site-labor charges for installation.

In addition the current method of onsite waterfeature construction is much more laborious and especially messy and creates great inconvenience for the owner. Two to three days of construction to as much as 10 days to 2 weeks is typically required for a properly installed natural stone watergarden.

Consequently, many pre-fabricated polyethylene water garden ponds lack aesthetic appeal and design, or are poorly installed, as such installations and designs depend on the skill and training of the installer. Additionally, time needed for installation is great, approximately two or three days generally, which drives up labor costs and the overall cost of the water garden to the consumer.

Accordingly, what is needed is a water garden that overcomes the drawbacks and problems of previous water gardens. The present invention solves these problems through a modular, freestanding, above ground, portable water garden system and method for constructing such units that will allow for installation in a much more common time frame, on the order of a couple of hours to no more than about 3 days.

### BRIEF SUMMARY OF THE INVENTION

In accordance with the invention, a portable, modular water garden structure, suitable for the containment of water and adapted to be readily assembled and disassembled, is provided. The term “modular” is intended to refer to something that is designed with standardized units or dimensions, as for easy assembly and repair or flexible arrangement and use.

The modular water garden structure of the invention first comprises a base unit, formed of a lightweight sturdy material, having an exposed outer surface, a top side, perimeter walls and an underside. The base unit is further characterized as having on its top side a generally centrally located depressed area suitable for use as a tub capable of accommodating an appropriate quantity of water. A moisture-proof flexible membrane is situated directly over the exposed outer surface area of the base unit, and extending over the tub and at least a portion of the upper edge of the perimeter walls. A layer of moisture- and flex-resistant material is formed over the moisture-proof membrane, covering the membrane and at least covering the exposed outside surfaces of the perimeter walls and any exposed outer surfaces of the base, so as to give a generally natural-looking appearance to said modular structure. One or more natural or natural-appearing stones may be attached to and or imbedded in said material to add to the appearance of the structure, as desired.

In another aspect of the present invention the modular structure includes a plumbing assembly having a pump; a water supply hose connected to the pump, at least one supply hose extending from the pump to the tub, allowing water supply to pass therethrough into the tub; and a return hose originating from within the tub and terminating at the pump to allow liquid within the tub to return to the pump.

In yet another aspect of the present invention, the modular structure is further characterized in that the base unit has at least one sloped area suitable for allowing water to run in a downward direction and a means whereby the water is collected and either returned to the pump or directed to a drain system.

In still another aspect of the present invention, the modular structure is further characterized in that at least four natural stones are imbedded in the moisture- and flex-resistant material covering the membrane.

Another aspect of the present invention is a method of constructing the above modular water garden, where the method comprises, obtaining one or more block(s) of polystyrene which can be in one piece or in multiple pieces and sealed together by an adhesive, forming a tub in the structure's base; applying a waterproofing membrane to the exposed surface of the base's tub, applying a suitable substrate material over the base's tub and walls, securing a mesh to the outside perimeter walls, applying the substrate material over the mesh and affixing one or more stones in the substrate material as aforementioned.

### BRIEF DESCRIPTION OF THE DRAWINGS

The accompanying drawings, in which like reference numerals refer to identical or functionally-similar elements throughout the separate views and which are incorporated in and form part of the specification, further illustrate the present invention and, together with the Detailed Description of the Invention, serve to explain the principles of the present invention.

FIG. 1 is a front perspective view of a modular structure's base for use in making modular water gardens according to the present invention.

FIG. 2 is a fragmented side sectional view of the modular structure's base for use in making modular water gardens according to the present invention.

FIG. 3 is a front perspective of mesh applied to the exposed surface of the modular structure's outside peripheral wall, and demonstrating a method for attaching the same.

FIG. 4 is a front perspective of mesh applied to the exposed surface of the modular structure's outside peripheral wall with a layer of moisture- and flex-resistant substrate over the mesh according to the present invention.

FIG. 5 is a partial perspective view of the method used to install the stone over the mesh and moisture- and flex-resistant substrate of a modular structure.

FIG. 6 is a perspective view of a modular water garden according to the present invention utilizing at least one modular structure.

FIG. 7 is a perspective view of another modular water garden according to the present invention utilizing at least one modular structure.

FIG. 8 is a perspective view of a modular water garden illustrating how several different modular structures may be combined to form a larger modular water garden.

FIG. 9 shows a basic schematic for a typical water filtration system for use in association with a modular water garden according to the present invention.

### DETAILED DESCRIPTION OF THE INVENTION

Preferred embodiments of the present invention are illustrated in the accompanying Drawings, like numerals being used to refer to like and corresponding parts shown in the various drawings. As will be apparent to those having ordinary skill in the art, however, the particular values and configurations discussed here can be varied and are cited merely to illustrate an embodiment of the present invention and are not intended to limit the scope of the invention.

With reference to the accompanying Drawings, FIG. 1 depicts a modular structure 10, having a base unit 12, having a body 14 with an exposed outer surface 16, perimeter walls 18 and an underside 20 which is formed of lightweight sturdy material, suitable for the containment of water and/or soil and adapted to be readily assembled and disassembled, for creating water gardens.

The base 12 is preferably made of expanded and extruded polystyrene foams (sometimes incorrectly called Styrofoam®, a Dow Chemical Co. trademarked form of polystyrene foam insulation). As will be apparent to those having skill in this art, the base unit could be constructed of a skeletal framework made of metal, wood, or some other suitable supporting frame structure, with a body made of plastic, papier-mâché, or some other suitable material providing the appropriate body characteristics of sturdiness, durability and light weight.

Foamed polystyrene is typically used to make cups, bowls, plates, trays, clamshell containers, meat trays and egg cartons as well as protective packaging for shipping electronics and other fragile items. In the construction field, it has proven useful due to the fact that it resists moisture, provides for insulation, is easily shaped, is lightweight and therefore easily transportable, and maintains its strength and structural integrity even after long periods of time. These are some of the reasons why polystyrene foam is preferred as the base material for the present invention. More reasons will become apparent as we discuss the invention further below.

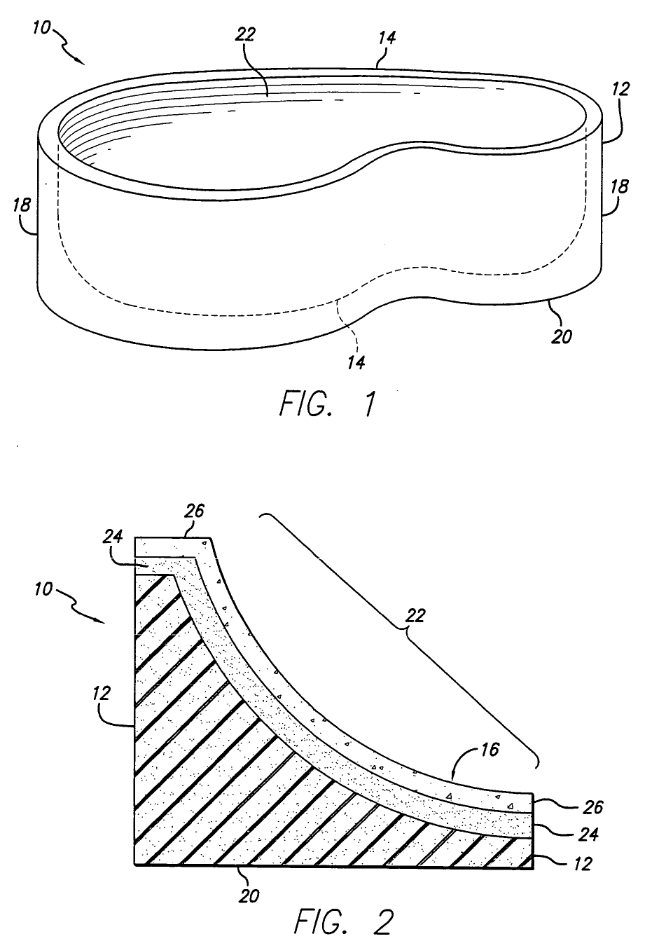

As further shown in FIGS. 1 and 2, the base unit 12 has a generally tub-shaped depressed area 22 capable of accommodating a quantity of liquid and/or soil that is centrally located on one surface thereof.

With reference to FIG. 2, the modular structure 10 shown therein comprises a base 12, a moisture-proof membrane 24, and a moisture- and flex-resistant substrate 26. It is feasible to combine the moisture and flex-resistant characteristics into a single layer and, at times, it is appropriate and expedient to use more than a single membrane over a substrate. These variations are within the skill of the art.

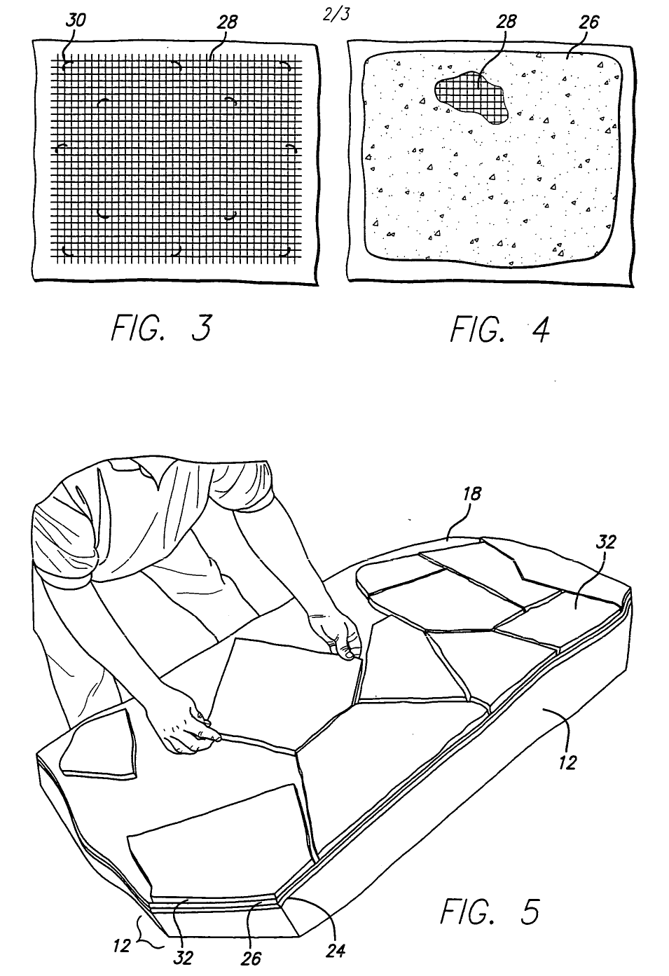

FIG. 3 demonstrates a portion of mesh 28 applied to the exposed surface of the modular structure's outside perimeter wall 18, and demonstrates a method for attaching the same, employing a simple stapling operation. The mesh is not essential to the invention but is recommended to help give support and structural integrity to the substrate.

FIG. 4 demonstrates a portion of mesh 28 applied to the exposed surface of the modular structure's outside perimeter wall 18 with a layer of moisture- and flex-resistant substrate 26 over the mesh.

The modular structure of the invention is characterized by its portability, cost-efficiency and ease of assembly that can best be demonstrated through a description of a preferred method of constructing the same.

The modular base structure 10 is prepared by first obtaining a block(s) of foamed polystyrene, which can be in one piece or in multiple pieces that may be sealed together by an adhesive, such as Liquid Nails adhesives, depending on the desired shape and size of the desired water garden.

In order to provide a base unit 10 with a tub-shaped depression capable of accommodating a quantity of liquid, a cavity 22 must be formed. In the preferred embodiment of the present invention, where the base is made of foamed polystyrene, this is conveniently done by using a heated cutting element, such as a hot wire, to cut the foam and form a depression of suitable size and shape by melting through it.

As clearly shown in FIG. 2 a waterproofing membrane 24 is formed over the exposed area of the tub and the upper edge of the perimeter wall(s). This layer prevents moisture from penetrating the base and helps to maintain the integrity of the base 10. The ideal material to use in this application would be an uncoupling, supporting, and waterproofing membrane that not only provides a moisture barrier but also prevents damage from movement. An example of such a membrane would be an EPDM rubber having a thickness of about 40-80 mils. Such membrane could be applied from the low point of the tub to the high point of the tub so that laps shed water. The full width membrane should be laid flat avoiding wrinkles and entrapped air. Each succeeding sheet of membrane should be applied with the specified overlapping of the side and end laps if multiple modular structures are combined. A preferred membrane is the “UtraGard” single ply, non-reinforced EPDM (ethylene propylene diene monomer) roofing membrane sold by Johns Manville Company of Denver Colo. It is a black, rubbery membrane, 45 mils (1.1 mm) thick, that is resistant to weathering and moisture.

It is also know in the industry to use a liquid that is applied by spray, roller, or trowel to form a suitable membrane. The liquid cures into a rubbery coating on the exposed area of the tub and the upper edge of the perimeter wall(s). One manufacturer has a spray-applied liquid membrane composed of polymer-modified asphalt. Polyurethane liquid membranes in separate grades for trowel, roller, or spray are also available from various manufacturers. Liquid coatings have the advantages of quick application, low in-place cost, and excellent elongation. One of the chief disadvantages is the possible inconsistency in coverage. The typical application thickness is 60 mils, but it takes a careful applicator to be sure of always achieving that minimum coverage.

With cementitious membranes, a waterproofing membrane is formed over the exposed area of the tub and the upper edge of the perimeter wall(s). Cementitious membranes are readily available from suppliers of masonry products. Acrylic polymer mortar additives (a white, milky liquid) make the membrane suitably flex- and moisture-resistant are also available from the suppliers of the cement product membrane material. A preferred such additive is called “acrylic mortar admix #3003” and may be obtained from Custom Building Products, Inc., of Bell, Calif. Using such material with the cement product will achieve better bonding and a more solid, durable coating for purposes of this invention.

It is also feasible to use a hot-mopped, asphalt-and-felt built-up system as a waterproofing membrane formed over the exposed area of the tub and the upper edge of the perimeter wall(s). With these types of membranes, a concrete primer is first applied with a coating of hot tar over the concrete primer, followed immediately by application of a sheet of perforated felt, extending the system right out onto the footing. The felt sheets are then staggered until there are two or three layers of felt with a final coating of tar. This is a good system with a lot of strength, but probably not much elongation ability. A similar built-up waterproofing membrane can also be used using cold, trowel-grade damp-proofing and reinforcing fabric. Again, this system has some strength but little elasticity.

Still further, Sodium bentonite, a clay material, has enjoyed a steady upsurge in popularity over the past several years as a waterproofing membrane. Sodium bentonite has become the choice of a growing number of architects and builders. Sodium bentonite works because it can absorb a tremendous amount of water. As it takes in water, the clay swells to 15 times its original volume and pushes itself into cracks and voids. When it reaches its maximum volume, it stays in these areas permanently to seal against water.

FIG. 2 also shows a moisture- and flex-resistant substrate 26 formed over the exposed outer surfaces 16 of the base 10 and covering the exposed outside surfaces of the perimeter walls 18.

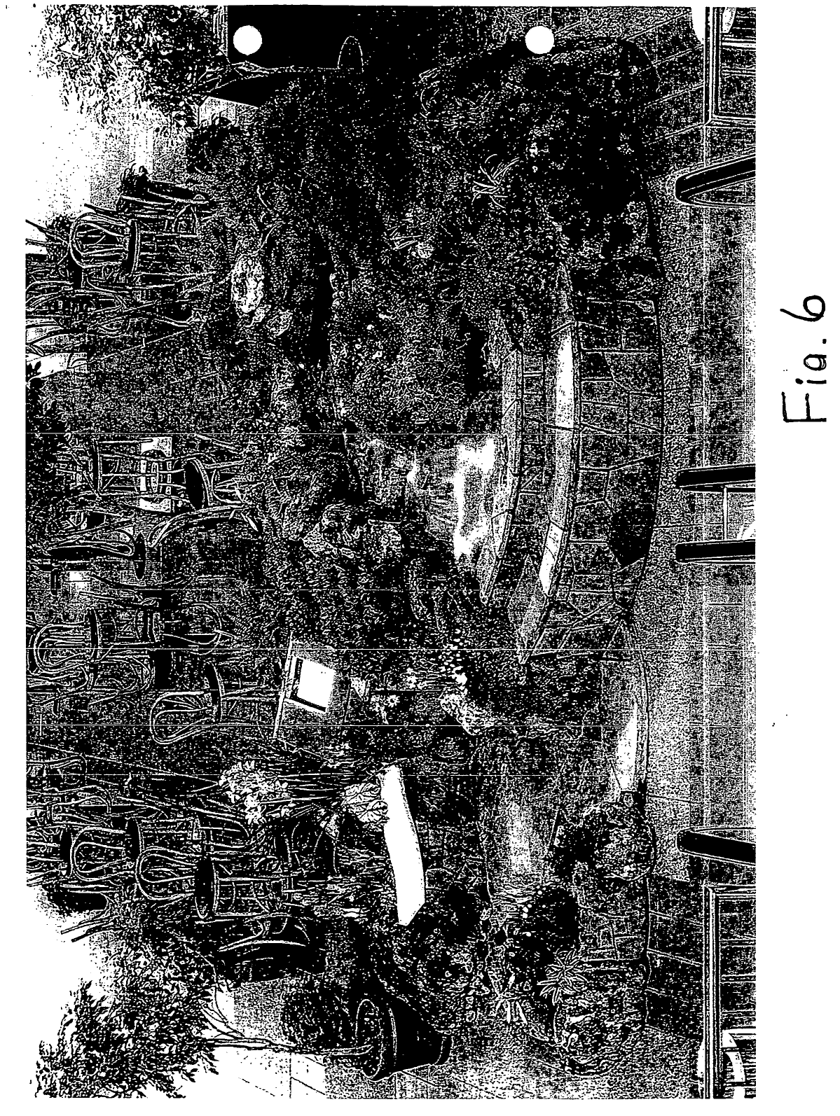

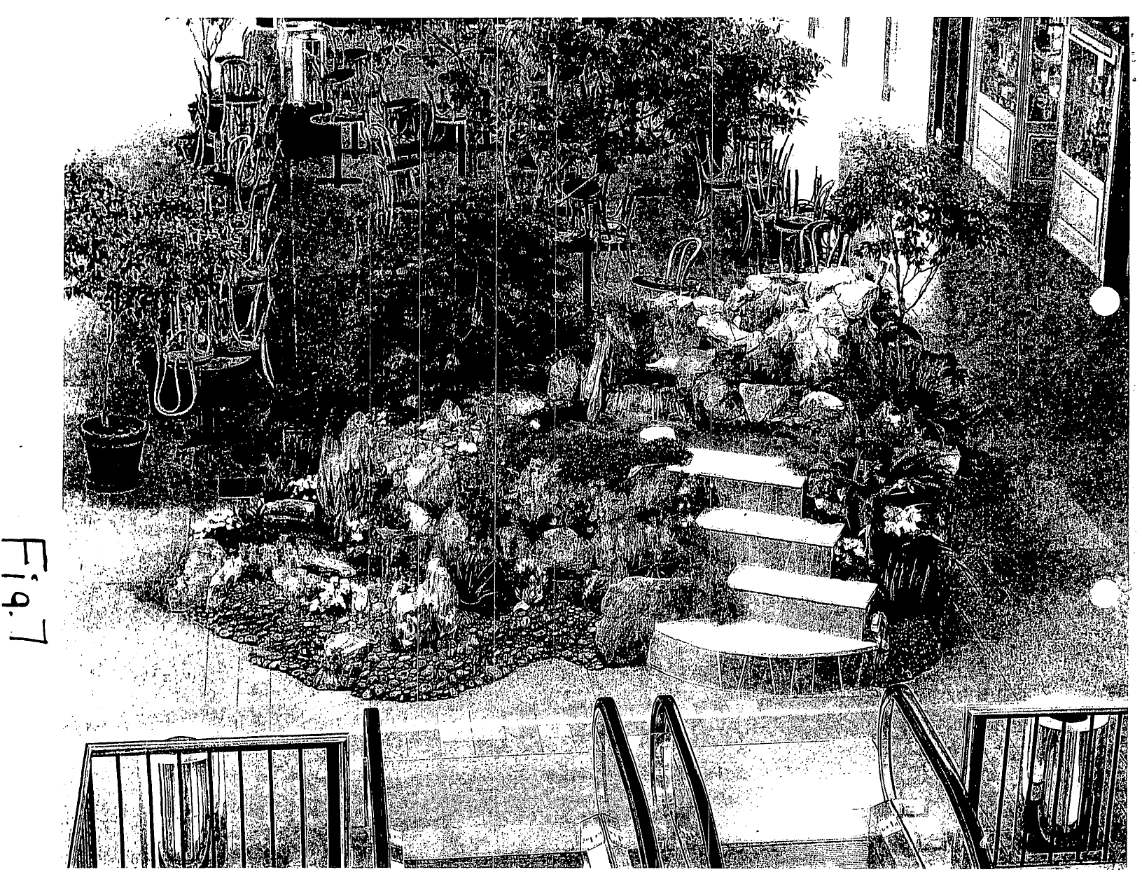

FIGS. 3 through 5 demonstrate the procedure for securing natural stone 32 to the base 10. There are two basic variations of the stone installation procedure, giving two distinct finished appearances. These are (1) the Standard installation procedure and (2) the Jointless or Dry-Stacked installation procedure. The Standard installation procedure leaves grouted joints between all stones. The Jointless or Dry-Stacked installation procedure fits stones tightly together without grouted joints. While much of the installation procedure is the same for both variations, differences will be noted throughout this detailed description.

As a first step, a supporting mesh 28 is installed onto the exposed surface of the outside peripheral wall(s) 18. A glass fiber reinforcing mesh having at least a 12-ounce (340 gm) unit weight is preferred, in particular, the “Panzer” or “intermediate” mesh products obtained from Dryvit Systems of West Warwick, R.I., as it is easily shaped. However, even galvanized or non-galvanized diamond mesh expanded metal lath may also be used.

The mesh 28 is attached using galvanized nails or staples on center vertically and on center horizontally 30. If using a metal lath mesh 28, attach with the small cups pointing upwards and double wrap metal lath around all inside and outside corners.

The appropriate coat of substrate 26, preferably a cementitious mortar, is then applied over the mesh 28 and allowed to set. If using mortar, the mortar should be mixed to a firm but workable (not too wet, not too dry) consistency. The preferred mortar mix for standard installation, i.e. grouted joints, includes either: two parts Portland cement; one part lime; five to seven parts masonry sand, and water, or three parts Type S Masonry cement; five to seven parts masonry sand, and water. This mortar can be colored to complement the stone by adding iron oxide pigments. The mortar mix for jointless/dry-stacked installation, includes either: three parts Portland Cement; two parts Thinset Mortar; seven parts masonry sand; and water, or three parts Type S Masonry Cement; seven parts masonry sand; bonding agent; and water. For the best finished appearance, the Jointless/Dry-stacked mortar color should blend with the stone base color to help conceal the joint lines.

For standard installation procedure, apply the stone 32 from the top down. This helps to keep the stone clean. For Jointless/Dry-stacked installation, apply the stone 32 from the bottom up. Install the corners first for easiest fitting. Corner pieces have a long and a short return. These should be alternated in opposite directions on the wall corner.

Natural stones, or stones made to look natural but which have been formed or cut to a relatively thin thickness should be installed with uniform size grout joints. A consistent ½″ or less space around the stones is desirable. Long, straight, unbroken joint lines should be avoided.

When installing stone 32, special attention should be given to keeping the work level. Chalk lines should be snapped every 4″ to 8″ as a guide for keeping the installation level and then a level should be used during the installation of individual pieces. Also, it is of particular importance to frequently stagger the joint lines both vertically and horizontally.

For best fit, stones can be cut or shaped using a hatchet, widemouth nippers or a mason's trowel edge. Straight cuts can be made with a diamond or carbide saw blade. Cut edges should be turned so they are not visible (down when below eye level and up when above eye level). To help conceal cut or broken edges, cover them with mortar when grouting.

Using a mason's trowel, an even layer of mortar 26 is applied to the entire back of the stone, preferably to a relatively even ½″ thickness. Then the stone 32 is pressed firmly into place on the prepared wall surface, squeezing the mortar 26 out around all edges. Using a gentle wiggling action while pressing the stone 32 will insure a good bond.

For Jointless/Dry-stacked installations, it's important when setting the stone 32 that the edges of the stone are properly sealed with mortar to ensure a satisfactory bond. This can be achieved by working mortar generously to the back of each stone to allow ample mortar to squeeze out around all edges of the stone 32 as it is pressed onto the wall 18 and, after removing any excess mortar (using a mason's trowel or a margin trowel), applying a thin bead of mortar with a grout bag to the edges of all previously installed adjacent stones, to fill any voids along a stone's exposed edges, prior to setting each stone.

If the stone is being installed onto a very dry surface or in a hot/dry climate, it is advisable to wet the stone 32 and wall surface 18 in order to prevent excessive absorption of moisture from the mortar 26. Spraying or brushing water onto the back of the stone 32 and the wall surface 18 and/or by dipping the stone 32 into a container of water can do this. In either case, the stone 32 and the wall surface 18 should be allowed to dry for a few minutes after wetting to eliminate excess surface water. For Jointless/Dry-stacked installations it will be necessary to wet the stones 32 regardless of the weather conditions.

It is not necessary to grout Jointless/Dry-stacked installation joints because the stone 32 edges should have already been properly sealed when the stone 32 was applied to the wall. However, it is sometimes desirable to do touch-up grouting to fill noticeable voids and to conceal cut or broken stone 32 edges.

When the mortar joints become firm (normally 30-60 minutes), a wooden or metal striking tool is used to rake out the excess mortar 26 to the desired depth while at the same time forcing the mortar into the joints so as to thoroughly seal the stone 32 edges.

After working the joints, a whiskbroom is typically used to smooth the joints and clean away any loose mortar 26 from the joints and stone face. Loose mortar 26 and mortar spots, which have set for only a few hours, clean up easily and should never be allowed to set up overnight.

Sealing the stones is usually not necessary, or even desired. However, it may be desirable for attaining deeper colors and for minimizing possible staining in certain applications such as “at grade,” where mud might splash onto the stone or on fireplaces which are exposed to smoke and soot. Only good quality masonry sealers that are of the “penetrating breathable” type and either Silicon or Silane based should be used. The sealer should be tested for color change on several loose stones 32 before application, as sealers will darken stone 32.

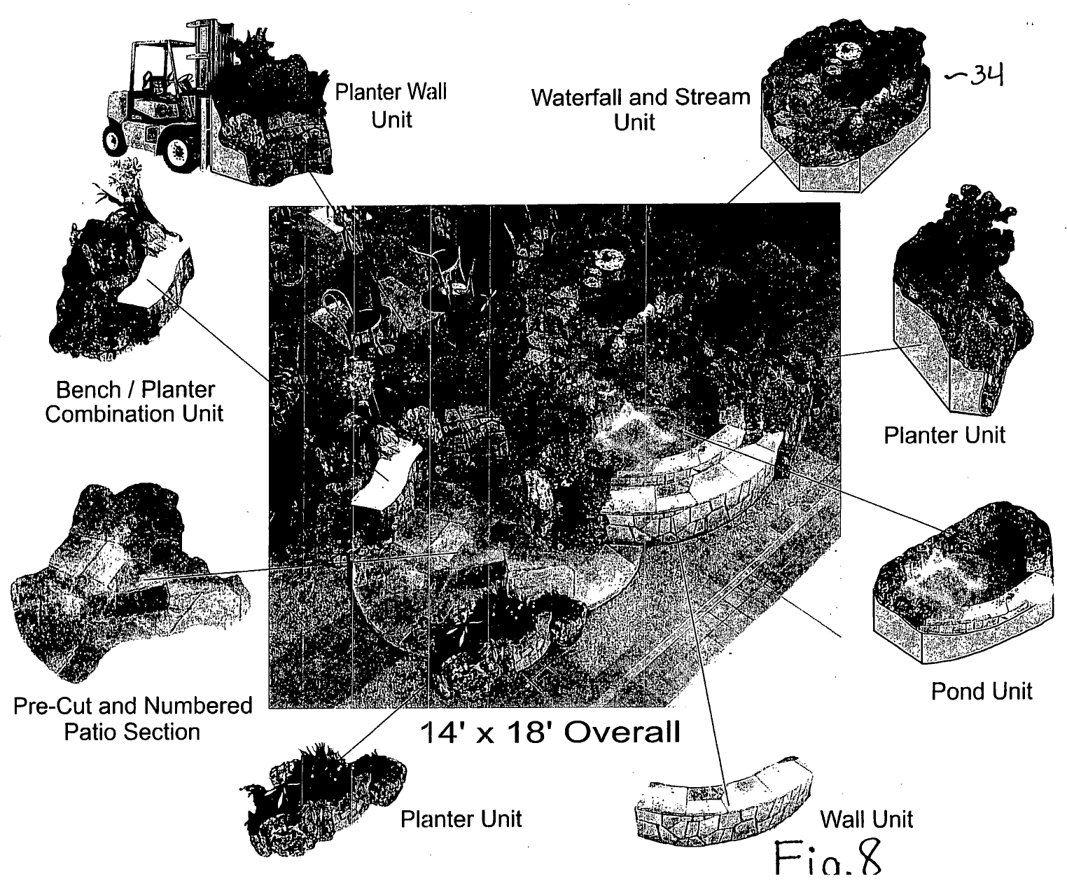

FIGS. 6 through 7 demonstrates how the above constructed modular structure can be combined with other modular structures to form a singular intricate water garden.

FIG. 8 demonstrates how one modular structure forms a waterfall 34. The waterfall 34 serves three functions, 1) the means by which water would re-enter the combined water garden; 2) a means of aerating the pond water providing oxygen for fish and other pond life; and 3) an aesthetic accentuation to the pond, both visually and with sound. This construction is used as demonstrated above except the modular waterfall structure 34 does not require an area of depression but may have more than one area of depression to form what are generally referred to as “catch basins” or exposed areas that allow water to flow in a downward direction. These catch basins can be mini-versions of the main pond.

If the modular waterfall structure 34 utilizes basins, a waterfall lip is placed between an upper basin and a lower basin, as well as the lip between the lower basin and the main pond. These waterfall lips act as a convenient medium by which water flow may be directed from catch basin to catch basin, and then into the main pond via the force of gravity.

As for the plumbing in a combined water garden including at least one modular structure and one modular waterfall structure 34, a pump is placed outside the modular structure 34, and pipe, preferably PVC, is run from the modular waterfall structure 34 to the pump/filter and then down to the upper catch basin within the waterfall. The necessary electrical equipment for the pump is run from the pond up to a near by electrical output. Most pumps can push water up to the top of the modular waterfall structure at an approximate rate of 600 gallons per hour. Gravity would then take affect and allow the water to run in a downward direction.

The waterfall acts as one of the best, most efficient biological filters because it has a tremendous amount of wet surface area that harbors beneficial bacteria. With constant water flow over these irregular surfaces, bacteria thrive and process organic pollutants out of the water. Particles of soil and organic debris that are suspended in the water settle out as the water flows over the falls. The water is also cooled and oxygenated as it moves over the stone surfaces. These are the essential components of manufactured bio-filters, just in a natural form.

Most filtration units can also be used with any of the above modular structures 10, including the modular waterfall structure 34. For example, a filtration unit can be placed outside the modular structures 10 and PVC pipe can be run from the pond up to the filter and then down to the upper catch basin within the modular waterfall structure.

In a preferred embodiment, the necessary electrical equipment for the pump can be run from the pond up to the filtration unit and then to a nearby electrical output. The pump that will then pushed water up to the filtration. Gravity would then take affect and aid the pump in pushing the water out of the filtration unit and down to the upper catch basin.

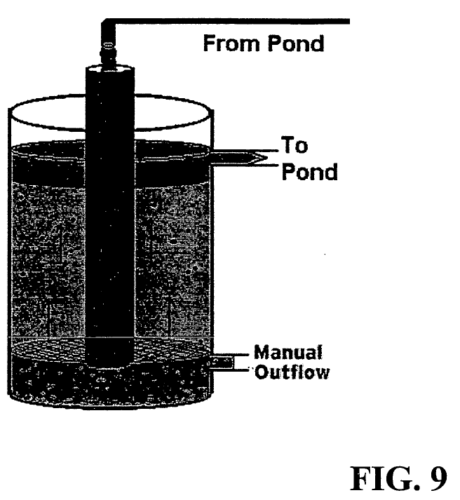

The schematics of one filtration unit are described in FIG. 9. What can be seen within this image is the basic schematic for the filtration system. Water from the pond enters the filtration system from the top. It is then forced down to the bottom of the barrel through a 3-inch to 6-inch diameter pipe as a result of the force applied by the pump. The water then percolates up through a media composed of course pea gravel. The idea is that all the dirt and sludge within the pond water settles below the screen and pea gravel. Simply opening up the manual outflow valve and letting it drain out can then theoretically remove all of this dirt and sludge. Clean water is then pumped out of the filtration system down to the pond where it enters the waterfall though the upper catch basin. The water is then sent down the waterfall via gravity where it then re-enters the pond. The pump pushes water out of the pond at an approximate rate of 600 gallons per hour.

The present invention described herein, therefore, is well adapted to carry out the stated objects and aspects and attain the ends and advantages mentioned, as well as others inherent therein. While presently preferred embodiments of the invention have been set forth for purposes of disclosure, those skilled in this art will understand that numerous changes are possible in the details of construction and procedures for accomplishing the desired results without deviating from the invention. Such modifications will readily suggest themselves to those skilled in the art, and are intended to be encompassed within the spirit of the present invention disclosed herein and the scope of the appended claims.

1. A modular structure, suitable for the containment of water and adapted to be readily assembled and disassembled, for creating water gardens, said modular structure comprising:
a base,
formed of a lightweight sturdy and durable moisture-resistant material,
having a body with perimeter walls, a top side and an underside,
said base further characterized as having a generally centrally located depressed area on its top side that is capable of accommodating and/or directing the flow of a quantity of aqueous liquid;
a moisture-resistant membrane
formed over the exposed outer surface area of the base structure, and
extending at least over the top side thereof and a portion of the upper edge of the perimeter walls;
a moisture- and flex-resistant substrate
extending over and on top of said moisture-resistant membrane and at least covering the exposed outside surfaces of the top and perimeter walls of the base, and
at least one natural-appearing stone
attached to and/or imbedded in said substrate such as to give a generally natural appearance to said modular structure.

2. The modular structure of claim 1, wherein the moisture-resistant membrane and substrate are formed of a single unitary material.

3. The modular structure of claim 1, wherein the base of the modular structure includes a plumbing assembly having:
a pump;
a supply hose, connected to the pump, that extends to a port at the exterior surface of the structure; and
a return hose originating from within a depressed area on the surface of the structure and terminating at the pump to allow for a return of aqueous liquid to the pump.

4. The modular structure of claim 1, wherein the width and depth of the centrally located depressed area are sufficient to hold one or more human beings.

5. The modular structure of claim 1, wherein said membrane has a thickness of at least about 40-80 mils.

6. The modular structure of claim 1, wherein at least four natural stones are imbedded into the substrate.

7. A modular structure, suitable for the containment of water and adapted to be readily assembled and disassembled, for creating water gardens, said modular structure comprising:
a base unit,
formed of a suitable lightweight material,
having a body with an exposed outer surface, perimeter walls and an underside,
said base unit further characterized as having a generally centrally located depressed area on its exposed outer surface that is suitable for use as a tub capable of accommodating a quantity of liquid;
a moisture-proof membrane
formed over the exposed outer surface area of the base structure, and
extending over at least the tub and the upper edge of the perimeter walls;
a moisture- and flex-resistant substrate
formed over the exposed outer surface of the base at least covering the exposed outside surfaces of the perimeter walls;
said substrate having one or more stones attached to and or imbedded therein such as to give a generally natural appearance to said modular structure; and
a plumbing assembly
including a pump and at least one hose adapted to supply flowing water to said modular structure.

8. A modular structure as in claim 7, combined into a water garden including at least one modular structure according to claim 1.

9. A modular structure suitable for the containment of water and adapted to be readily assembled and disassembled, for creating water gardens, said modular structure comprising:
a base,
formed of lightweight sturdy material, suitable to support the weight of the structure and give it a transportable character,
having a body with an exposed outer surface, perimeter walls and an underside,
said base further characterized as having at least one sloped area suitable for allowing water to run in a downward direction;
a moisture-proof membrane
formed over the exposed outer surface area of the sloped area, and
a moisture- and flex-resistant substrate
formed over the exposed outer surface area of the sloped area at least covering the exposed outside surfaces of the perimeter walls, and characterized as providing a generally natural appearance to said modular structure.

10. The modular structure of claim 8, wherein at least one natural-appearing stone is attached to and/or imbedded in said substrate such as to give a generally natural appearance to said modular structure.

11. The modular structure of claim 10, wherein a fiberglass mesh reinforcing material is secured to the base unit before applying the substrate.
